(19) United States
(12) Patent Application Publication
(10) Pub. No.: US 2024/0174201 A1
(43) Pub. Date: May 30, 2024

(54) VEHICLE CLEANING SYSTEM

(71) Applicant: TOYOTA JIDOSHA KABUSHIKI KAISHA, Toyota-shi Aichi-ken (JP)

(72) Inventors: Kenji HOSHI, Gotenba-shi Shizuoka-ken (JP); Teruaki HAIBARA, Ashigarakami-gun Kanagawa-ken (JP); Masaaki SATO, Susono-shi Shizuoka-ken (JP); Takeru SHIRASAWA, Sunto-gun Shizuoka-ken (JP)

(73) Assignee: TOYOTA JIDOSHA KABUSHIKI KAISHA, Toyota-shi Aichi-ken (JP)

(21) Appl. No.: 18/512,773

(22) Filed: Nov. 17, 2023

(30) Foreign Application Priority Data
Nov. 28, 2022 (JP) 2022-189279

(51) Int. Cl. B60S 3/00; B25J 11/00

(52) U.S. Cl. CPC B60S 3/008; B25J 11/0085

(57) ABSTRACT

A vehicle cleaning system includes: a vehicle; and a cleaning robot that cleans the vehicle. Further, the vehicle and the cleaning robot mutually perform communication of information necessary for cleaning, and perform cleaning at appropriate timing.

### CROSS-REFERENCE TO RELATED APPLICATION(S)

The present application claims priority to and incorporates by reference the entire contents of Japanese Patent Application No. 2022-189279 filed in Japan on Nov. 28, 2022.

### BACKGROUND

The present disclosure relates to a vehicle cleaning system.

Japanese Laid-open Patent Publication No. 2021-101272 discloses a technology of prompting vehicle cleaning by transmitting vehicle cleaning information to at least one of a user terminal or a maintenance management server by a vehicle cleaning support unit when a dirtiness factor element in a vehicle interior is recognized.

### SUMMARY

There is a need for providing a vehicle cleaning system capable of cleaning a vehicle at appropriate timing.

According to an embodiment, a vehicle cleaning system includes: a vehicle; and a cleaning robot that cleans the vehicle. Further, the vehicle and the cleaning robot mutually perform communication of information necessary for cleaning, and perform cleaning at appropriate timing.

### BRIEF DESCRIPTION OF THE DRAWINGS

FIG. 1 is a view illustrating a schematic configuration of a vehicle cleaning system according to an embodiment;

FIG. 2 is a block diagram illustrating a functional configuration of the vehicle cleaning system according to an embodiment; and

FIG. 3 is a flowchart illustrating an outline of processing executed by a cleaning system according to an embodiment.

### DETAILED DESCRIPTION

In the related art, for example, in Japanese Laid-open Patent Publication No. 2021-101272, any specific cleaning method or the like after vehicle cleaning information is transmitted is not considered and there is room for improvement.

Hereinafter, a vehicle cleaning system according to an embodiment of the present disclosure will be described with reference to the drawings. Note that the present disclosure is not limited to the following embodiment. Furthermore, in the following description, the same portions are denoted by the same reference signs.

### Outline of a Vehicle Cleaning System

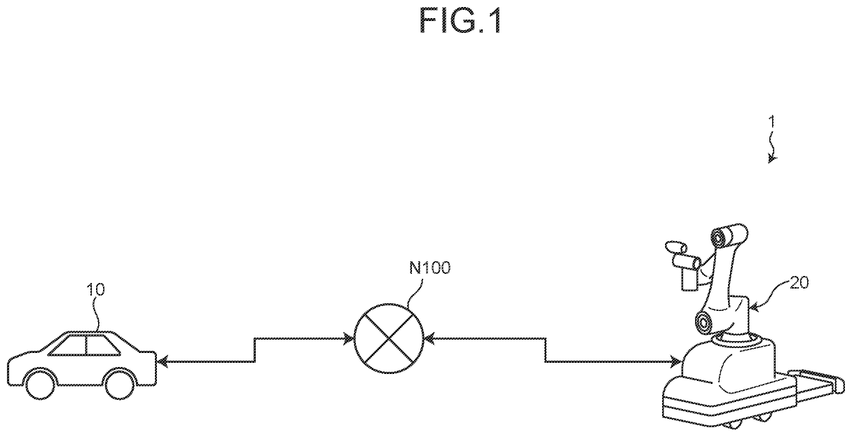

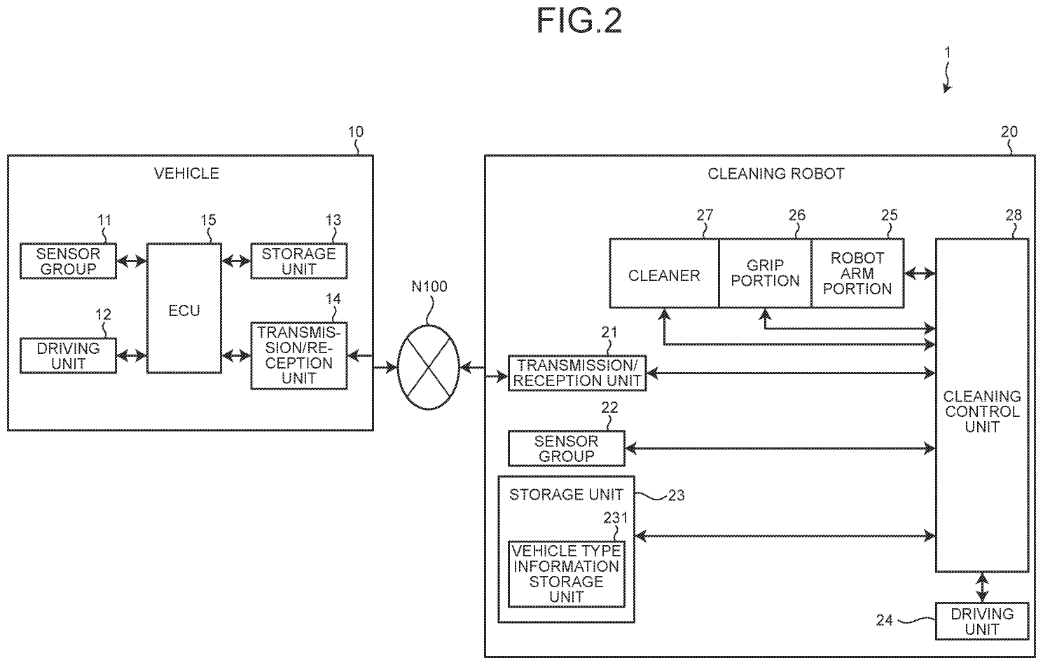

FIG. 1 is a view illustrating a schematic configuration of a vehicle cleaning system according to one embodiment. FIG. 2 is a block diagram illustrating a functional configuration of the vehicle cleaning system according to the one embodiment.

A cleaning system 1 illustrated in FIG. 1 and FIG. 2 includes a vehicle 10 and a cleaning robot 20. The vehicle 10 is assumed to be a hybrid electric vehicle (HEV), a plug-in hybrid electric vehicle (PHEV), a battery electric vehicle (BEV), a fuel cell electric vehicle (FCEV), and the like. The cleaning robot 20 can communicate with the vehicle 10 via a network N100, and cleans the vehicle 10 at predetermined timing. The network N100 is assumed to include, for example, the Internet network, Wi-Fi, Bluetooth (registered trademark), a mobile phone network, and the like.

### Functional Configuration of a Vehicle

First, a functional configuration of the vehicle 10 will be described.

The vehicle 10 includes a sensor group 11, a driving unit 12, a storage unit 13, a transmission/reception unit 14, and an electronic control unit (ECU) 15.

The sensor group 11 includes a wiper operation detection sensor, a door opening/closing sensor, a seat sensor, an imaging device, a speed sensor, an acceleration sensor, a gyroscope sensor, and the like. The sensor group 11 detects operation of a wiper (not illustrated) and outputs a result of the detection to the ECU 15. In addition, the sensor group 11 detects opening and closing of a door of the vehicle 10 and outputs a result of the detection to the ECU 15. Furthermore, the sensor group 11 detects a position of a passenger seated on a seat in the vehicle 10, and outputs a result of the detection to the ECU 15. Furthermore, the sensor group 11 images the inside of the vehicle 10, generates image data, and outputs the image data to the ECU 15. In addition, the sensor group 11 detects a state of the driving unit 12 and outputs a result of the detection to the ECU 15.

The driving unit 12 is realized by utilization of an engine, a motor, or the like. The driving unit 12 accelerates the vehicle 10 by driving under control of the ECU 15.

The storage unit 13 is realized by utilization of a read only memory (ROM), a random access memory (RAM), a solid state drive (SSD), a hard disk drive (HDD), and the like. The storage unit 13 stores an operating system (OS), various programs, various tables, various databases, and the like. In addition, the storage unit 13 stores a vehicle ID for identifying the vehicle 10, vehicle type information of the vehicle 10, a model year, an operation history of the wiper, elapsed days of use of the vehicle 10 after previous cleaning, a seating position of a passenger, a history of opening and closing of a door, and the like.

The transmission/reception unit 14 bidirectionally communicates with the cleaning robot 20 via the network N100 under the control of the ECU 15. For example, the transmission/reception unit 14 communicates with the cleaning robot 20 by Wi-Fi, Bluetooth (registered trademark), or the like. The transmission/reception unit 14 is configured by utilization of, for example, a communication module having an antenna.

The ECU 15 is realized by utilization of a processor having hardware. A hard disk is, for example, a memory, a central processing unit (CPU), a digital signal processor (DSP), a field-programmable gate array (FPGA), a graphics processing unit (GPU), or the like. The ECU 15 controls each unit included in the vehicle 10. The ECU 15 realizes a function that meets a predetermined purpose by loading and executing a program, which is stored in the storage unit 13, in a work area of the memory and controlling each configuration unit and the like through execution of the program. Specifically, the ECU 15 transmits vehicle information to the cleaning robot 20 in a case where the vehicle 10 satisfies a predetermined condition. Here, the predetermined condition is a state in which the vehicle 10 enters a return place and stops and there is no occupant in the interior of the vehicle 10 according to the sensor group 11 provided in the vehicle 10. Note that the ECU 15 functions as a first processor in the one embodiment.

### Functional Configuration of a Cleaning Robot

Next, a functional configuration of the cleaning robot 20 will be described. The cleaning robot 20 includes a transmission/reception unit 21, a sensor group 22, a storage unit 23, a driving unit 24, a robot arm portion 25, a grip portion 26, a cleaner 27, and a cleaning control unit 28.

The transmission/reception unit 21 bidirectionally communicates with the vehicle 10 via the network N100 under control of the cleaning control unit 28. For example, the transmission/reception unit 21 communicates with the vehicle 10 by Wi-Fi, Bluetooth (registered trademark), or the like. The transmission/reception unit 21 is configured by utilization of, for example, a communication module having an antenna.

The sensor group 22 includes a GPS sensor, a dirt detection sensor, a humidity sensor, an infrared sensor, a speed sensor, an acceleration sensor, a gyroscope sensor, and the like. For example, the sensor group 22 detects dirt on the vehicle 10, and outputs a result of the detection to the cleaning control unit 28. In addition, the sensor group 22 detects a position of the cleaning robot 20, and outputs a result of the detection to the cleaning control unit 28. Furthermore, the sensor group 22 detects a speed of the cleaning robot 20, and outputs a result of the detection to the cleaning control unit 28.

The storage unit 23 is realized by utilization of a ROM, a RAM, an SSD, an HDD, and the like. The storage unit 23 stores an operating system, various programs, various tables, various databases, and the like. In addition, the storage unit 23 includes a vehicle type information storage unit 231. The vehicle type information storage unit 231 stores a vehicle ID and vehicle type information associated with the vehicle ID. Here, the vehicle type information includes a shape of an interior, a model year, a material and a color of a seat, and the like of the vehicle 10.

The driving unit 24 is realized by utilization of a tire, a continuous track, an engine, a motor, or the like. The driving unit 24 moves the cleaning robot 20 to a predetermined position by driving under the control of the cleaning control unit 28.

The robot arm portion 25 rotatably supports the grip portion 26 that rotatably grips the cleaner 27. The robot arm portion 25 is configured by utilization of a support portion that can at least rotate about axes orthogonal to each other, a motor provided on each axis, and the like. Under the control of the cleaning control unit 28, the robot arm portion 25 moves the grip portion 26 to a predetermined position in a space.

The grip portion 26 is provided at a distal end of the robot arm portion 25 in such a manner as to be rotatable with respect to the robot arm portion 25. The grip portion 26 grips the cleaner 27 and the like. The grip portion 26 grips a predetermined device under the control of the cleaning control unit 28.

Under the control of the cleaning control unit 28, the cleaner 27 cleans dust and dirt in the vehicle interior, on seats, and the like in the vehicle 10. Note that although the cleaner 27 is described as an example of what is gripped by the grip portion 26 in the one embodiment, he cleaner 27 is not limited thereto. For example, an ultraviolet irradiation device that can perform sterilization, or the like may be used.

The cleaning control unit 28 is realized by utilization of a processor having hardware. A hard disk is, for example, a memory, a CPU, a DSP, an FPGA, or the like. The cleaning control unit 28 controls each unit included in the vehicle 10. The ECU 15 realizes a function that meets a predetermined purpose by loading and executing a program, which is stored in the storage unit 23, in a work area of the memory and controlling each configuration unit and the like through execution of the program. Specifically, the cleaning control unit 28 determines a cleaning area and a cleaning method of the vehicle 10 on the basis of the vehicle information received from the vehicle 10, and cleans the vehicle 10 by the cleaning robot 20 on the basis of the cleaning area and the cleaning method of the vehicle 10. Then, in a case where cleaning of the vehicle 10 by the cleaning robot 20 is completed, the cleaning control unit 28 transmits cleaning completion information to the vehicle 10. In addition, the cleaning control unit 28 determines the cleaning area and the cleaning method of the vehicle 10 on the basis of a use history of the vehicle 10 and seating history information of the occupant. Furthermore, the cleaning control unit 28 determines the cleaning area and the cleaning method on the basis of the shape of the interior of the vehicle 10 and the material of the seat in the vehicle type information associated with the vehicle ID included in the vehicle information. Note that the cleaning control unit 28 functions as a second processor in the one embodiment.

### Processing by a Cleaning System

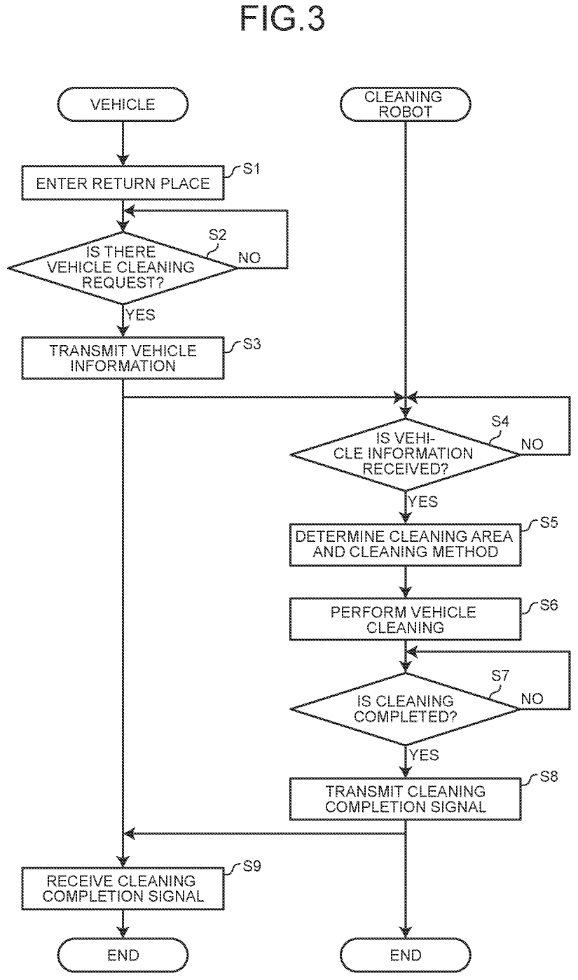

Next, processing executed by the cleaning system 1 will be described. FIG. 3 is a flowchart illustrating an outline of the processing executed by the cleaning system 1.

As illustrated in FIG. 3, first, the vehicle 10 enters a predetermined return place (Step S1), and the ECU 15 determines whether there is a vehicle cleaning request (Step S2). Specifically, the ECU 15 determines whether the vehicle 10 is stopped and an occupant is absent in the vehicle 10 on the basis of various detection results input from the sensor group 11. In this case, the ECU 15 determines that there is the vehicle cleaning request when the vehicle 10 is stopped and the occupant is absent in the vehicle 10. In a case where the ECU 15 determines that there is the vehicle cleaning request (Step S2: Yes), the vehicle 10 proceeds to Step S3. On the other hand, in a case where the ECU 15 determines that there is no vehicle cleaning request (Step S2: No), the vehicle 10 performs the processing of Step S2 at every predetermined timing.

In Step S3, the ECU 15 transmits vehicle information to the cleaning robot 20 via the transmission/reception unit 14. Here, the vehicle information includes a vehicle ID, position information of the vehicle 10, elapsed days of use of the vehicle 10 after previous cleaning with respect to the vehicle 10, a wiper operation history, seating position information, a door opening/closing history, and the like.

Subsequently, the cleaning control unit 28 determines whether the vehicle information is received from the vehicle 10 (Step S4). In a case of determining that the vehicle information is received from the vehicle 10 (Step S4: Yes), the cleaning control unit 28 proceeds to Step S5. On the other hand, in a case of determining that the vehicle information is not received from the vehicle 10 (Step S4: No), the cleaning control unit 28 waits until the vehicle information is received from the vehicle 10.

In Step S5, the cleaning control unit 28 determines the cleaning area and the cleaning method of the vehicle 10 on the basis of the vehicle information received from the vehicle 10. For example, the cleaning control unit 28 determines the cleaning area and the cleaning method of the vehicle 10 on the basis of the shape of the vehicle 10, the material and the color of the seat, the number of elapsed days of use of the vehicle 10 after the previous cleaning, and the seating position information included in the vehicle information associated with the vehicle ID included in the vehicle information. Specifically, the cleaning control unit 28 determines the cleaning area and the cleaning method, in which intensive cleaning and sterilization are performed, with respect to a seat having a seating history of the occupant.

Subsequently, the cleaning control unit 28 performs vehicle cleaning on the basis of the cleaning area and the cleaning method of the vehicle 10 (Step S6). Specifically, the cleaning control unit 28 drives the driving unit 24 and moves the cleaning robot 20 toward the vehicle 10 that enters the return place. After arriving at the vehicle 10, the cleaning control unit 28 drives the robot arm portion 25, the grip portion 26, and the cleaner 27 and performs vehicle cleaning on the basis of the cleaning area and the cleaning method of the vehicle 10.

Then, the cleaning control unit 28 determines whether cleaning of the vehicle 10 is completed on the basis of a detection result from the sensor group 22 (Step S7). Specifically, the cleaning control unit 28 determines whether cleaning of the vehicle 10 is completed on the basis of a degree of dirtiness of the seat of the vehicle 10 which degree of dirtiness is detected by the sensor group 22. For example, in a case where the sensor group 22 no longer detects the degree of dirtiness of the seat of the vehicle 10, the cleaning control unit 28 determines that cleaning of the vehicle 10 is completed. Obviously, the cleaning control unit 28 may determine that cleaning of the vehicle 10 is completed in a case where the cleaner 27 cleans the cleaning area for a time set in advance. In a case where the cleaning control unit 28 determines that cleaning of the vehicle 10 is completed (Step S7: Yes), the cleaning robot 20 proceeds to Step S8. On the other hand, in a case where the cleaning control unit 28 determines that cleaning of the vehicle 10 is not completed (Step S7: No), the cleaning robot 20 repeats the determination of Step S7 until cleaning of the vehicle 10 is completed.

In Step S8, the cleaning control unit 28 transmits, to the vehicle 10, a cleaning completion signal indicating that cleaning of the vehicle 10 by the cleaning robot 20 is completed.

Subsequently, the ECU 15 receives the cleaning completion signal from the cleaning robot 20 (Step S9). Here, the cleaning completion signal includes information indicating that cleaning of the vehicle 10 is completed, information of a cleaning performed area of the vehicle 10, dirtiness details, and the like. After Step S9, the cleaning system 1 ends the present processing.

According to the one embodiment described above, since the vehicle 10 and the cleaning robot 20 mutually perform communication of information necessary for cleaning, it is possible to clean the vehicle 10 at appropriate timing.

Furthermore, according to the one embodiment, the cleaning control unit 28 determines the cleaning area and the cleaning method of the vehicle 10 on the basis of the vehicle information received from the vehicle 10, cleans the vehicle 10 by the cleaning robot 20 on the basis of the cleaning area and the cleaning method of the vehicle 10, and transmits the cleaning completion information to the vehicle 10 in a case where cleaning of the vehicle 10 by the cleaning robot 20 is completed. As a result, the cleaning robot 20 can perform cleaning according to the use history of the vehicle 10, and can transmit reliable cleaning completion timing to the vehicle 10.

Furthermore, according to the one embodiment, since the cleaning control unit 28 determines the cleaning area and the cleaning method of the vehicle 10 on the basis of the use history of the vehicle 10 and the seating history information of the occupant, cleaning according to the use history of the vehicle 10 can be performed.

Furthermore, according to the one embodiment, since the cleaning control unit 28 determines the cleaning area and the cleaning method on the basis of the shape of the interior of the vehicle 10 and the material of the seat, cleaning according to characteristics of a vehicle type of the vehicle 10 can be performed.

### Other Embodiments

Furthermore, although the cleaning control unit is provided in the cleaning robot in the cleaning system according to the one embodiment, a function of the cleaning control unit may be realized by one server.

In addition, in the cleaning system according to the one embodiment, “unit” described above can be replaced with “means”, “circuit”, or the like. For example, the storage unit can be replaced with a storage means or a storage circuit.

Furthermore, a program to be executed by the cleaning system according to the one embodiment is provided as file data in an installable or executable format while being recorded in a computer-readable recording medium such as a CD-ROM, a flexible disk (FD), a CD-R, a digital versatile disk (DVD), a USB medium, or a flash memory.

Note that in the description of the flowchart in the present description, although the expressions “first”, “then”, “subsequently”, and the like are used to clarify processing order of the steps, the processing order required to carry out the present embodiment is not defined uniquely by these expressions. That is, the processing order in the flowchart described in the present description can be changed within a range without contradiction.

According to the present disclosure, there is an effect that a vehicle can be cleaned at appropriate timing.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle cleaning system comprising: a vehicle; and a cleaning robot that cleans the vehicle, wherein
the vehicle and the cleaning robot
mutually perform communication of information necessary for cleaning, and
perform cleaning at appropriate timing.

2. The vehicle cleaning system according to claim 1, wherein
the vehicle includes
a first processor,
the cleaning robot includes
a second processor,
the first processor transmits vehicle information to the cleaning robot in a case where the vehicle satisfies a predetermined condition, and
the second processor determines a cleaning area and a cleaning method of the vehicle on a basis of the vehicle information received from the vehicle, cleans the vehicle by the cleaning robot on a basis of the cleaning area and the cleaning method, and transmits cleaning completion information to the vehicle in a case where cleaning of the vehicle by the cleaning robot is completed.

3. The vehicle cleaning system according to claim 2, wherein
the first processor determines, as the predetermined condition, a situation of an interior of the vehicle by using a sensor group provided in the vehicle in a case where the vehicle is stopped, and transmits the vehicle information in a case where there is no occupant in the interior.

4. The vehicle cleaning system according to claim 3, wherein
the vehicle information includes at least a use history of the vehicle and seating history information of an occupant, and
the second processor determines the cleaning area and the cleaning method on a basis of the use history and the seating history information.

5. The vehicle cleaning system according to claim 4, wherein
the second processor determines the cleaning area and the cleaning method on a basis of a shape of the interior of the vehicle and a material of a seat.
